(19) United States
(12) Patent Application Publication
(10) Pub. No.: US 2025/0273412 A1
(43) Pub. Date: Aug. 28, 2025

(54) STANDING REMOTE SLEEVE

(71) Applicant: Rassi LLC, Redondo Beach, CA (US)

(72) Inventor: Nima Ahmadi, Redondo Beach, CA (US)

(21) Appl. No.: 19/065,568

(22) Filed: Feb. 27, 2025

Related U.S. Application Data
(60) Provisional application No. 63/559,106, filed on Feb. 28, 2024.

(51) Int. Cl. H01H 9/02

(52) U.S. Cl. CPC H01H 9/025

(57) ABSTRACT

The present disclosure relates to a remote sleeve with an integrated standing feature that enables a media remote to remain in a stable upright position on a flat surface.

### CROSS-REFERENCE TO RELATED APPLICATIONS

This application claims priority to provisional application 63/559,106 filed on Feb. 28, 2024, which is incorporated herein in its entirety by reference.

### BACKGROUND

### Field

The present disclosure relates to a remote sleeve with an integrated standing feature that enables a remote to stand upright on a flat surface.

### Description of the Related Art

Many video and audio devices, e.g., televisions (TVs) and audio receivers, can be controlled using a wireless remote-control device or a “remote.” Conventional remotes are typically placed on a table when not in use, whereupon they are frequently covered with other items, e.g., magazines or napkins. Keeping the remote close at hand during use often results in the remote slipping onto the floor, or in between cushions of the furniture, making it difficult to locate. Existing solutions for this growing need include remote control trays in which the remote is placed. The remote being separate from the tray, however, invariably results in the remote being misplaced or hidden from view upon use. With the advent of multiple streaming media and other remote-controlled devices, users need a means of resting their remotes such that the remotes can be located with ease when needed.

### SUMMARY

The present invention is directed to a standing remote sleeve specifically engineered to facilitate the stable, upright, placement of television, smart streaming, or multi-media remotes on flat surfaces. The design of the standing remote sleeve of the present invention offers users a convenient storage option, ensuring the remote remains visible on a tabletop or any other flat surface post-use.

In certain embodiments, the standing remote sleeve of the present invention has additional integrated features that individually, or collectively, enhance the remote's functionality and/or enhance user's ability to locate the remote within the vicinity if misplaced. These embodiments include, but are not limited to, the incorporation of a silicone material in the standing remote sleeve of the present invention, the utilization of a diverse color selection in the standing remote sleeve of the present invention, the incorporation of a night-time glow effect in the standing remote sleeve of the present invention, the incorporation of embedded lights in the remote standing sleeve of the present invention, the integration of a tracker device holder or cavity in the standing remote sleeve of the present invention, the incorporation of uniquely positioned speaker cut-outs in the standing remote sleeve of the present invention, augmenting the size of the standing remote sleeve of the present invention to improve the ergonomics of the remote and further enhance the user's ability to locate the remote, incorporating a magnet in the standing remote sleeve of the present invention, and/or optimizing the wall thickness of the standing remote sleeve, e.g., 1.5 mm wall thickness of the silicone standing remote sleeve, such that the sleeve layer allows for coverage of the remote as well as utilization of the magnet functionality from the remote itself, which enables the remote to be used in conjunction with a separate remote mount that attaches the remote plus standing remote sleeve system to the remote mount

Accordingly, the present invention addresses an unmet need for an accessory that can be integrated with the remote and enable the remote to stand in an elevated position above a flat surface thereby making it more visible to the user and reducing the likelihood of it being obstructed by other items on the surface.

Embodiments of the present invention can be used with any type of remote control device shown in, for example, Table 1, e.g., remotes that work with Amazon Fire® devices or other Streaming Device Remotes, including, but not limited to, Roku®—Roku® Voice Remote/Roku® Voice Remote Pro, Apple TV® Remote—Siri® Remote (2nd Gen or 3rd Gen), Google TV™ Streamer—Google Chromecast™ with Google TV™ Remote, NVIDIA® Shield Pro—NVIDIA® Shield™ Remote, TiVo®—TiVOR Stream 4K Remote/TiVOR VOX™ Remote, Amazon Fire TVR Cube—Alexa® Voice Remote (3rd Gen), ONN™—ONN™ Android TV™ Remote, SuperBox S5 PRO™ by TV Technologies LLC—SuperBox S5 PRO™ Remote.

Embodiments of the present invention can also be used with any type of remote control device shown in for example Table 2, e.g., remotes that work with TV Brand Remotes: Sony®—Sony® Bravia® Smart TV Remote, Samsung®—Samsung® Smart Remote/Samsung® One Remote™, LG®—LGR Magic Remote™, Hisense®—Hisense® Voice Remote/Hisense® Standard IR Remote, TCL®—TCL® Roku® TV Remote/TCL® Android TV™ Remote, Vizio®—Vizio® XRT—Series Remote/Vizio® SmartCast™ Remote, Philips®—Philips® Universal Remote/Philips® Smart TV Remote, Panasonic®—Panasonic® VIERA® Remote/Panasonic® Smart TV Remote, Sharp®—Sharp® AQUOS® Remote/Sharp® Roku® TV Remote.

In embodiments that integrate a tracker device holder or cavity in the standing remote sleeve of the present invention, the standing remote sleeve comprises strategically positioned hole cut-outs along the bottom and sides of the remote sleeve walls. In such embodiments, the standing remote sleeve comprises a cavity that can incorporate a device tracker. In preferred embodiments, the standing remote sleeve comprises one cavity compatible with at least two device trackers. For example, in certain embodiments of the invention, the standing remote sleeve can integrate two or more tracking devices, selected from the group comprising, Apple® AirTag®, a Tile Pro®, a Tile Mate®, a Tile Slim®, a Tile Sticker®, and a Samsung Galaxy SmartTag®. device trackers, providing users the ability to use their existing tracker solutions for locating misplaced remotes. In preferred embodiments the standing remote sleeve of the present invention can integrate with either Apple® AirTag® or a Tile Mate® tracking device.

In such embodiments, the cavity orientation of the tracker device is strategically aligned to position the speaker of the tracker to direct the audible sound toward the back of the remote which facilitates the reflection of sound off the back of the remote housing instead of the standing remote sleeve, allowing it to escape the enclosed cavity through at least one of a bottom cut-out speaker channel and a side cut-out speaker channel in the standing remote sleeve of the present invention. The orientation of the cavity is critical because tracker devices oriented towards the silicone wall instead of through the bottom and side speaker cut-outs result in a muffling and distortion of the audible chime or sound from the tracker device, thereby compromising the effectiveness of locating the remote when lost.

In yet other embodiments, the standing remote sleeves of the present invention can be used with television smart streaming or multi-media remotes equipped with built-in tracking functionality. In these embodiments, the standing remote sleeve comprises strategically positioned hole cut-outs along the bottom and sides. The strategically positioned hole cut-outs along the bottom and sides of the standing remote sleeve enables the audible chime of these trackers to be clearly heard when activated, further enhancing the user's ability to locate the remote.

In certain embodiments, the standing remote sleeve of the present invention augments the overall size of the remote, contributing to a more comfortable grip during usage. In such embodiments, the standing remote sleeve's width and depth is increased to 100%, 200%, 300%, 400% or greater relative to the size of the enclosed remote, ensuring an ergonomic and user-friendly design that enhances the overall handling experience.

In certain embodiments, the standing remote sleeve of the present invention has embedded lights. By way of example and not limitation, integrated LED shines on buttons when triggered by pressure points by means of wires which relay pressure sensor trigger to main board to activate and light up the LED.

In one embodiment, the remote sleeve has an integrated stand feature built into the housing of the structure allowing the user to stand their remote without the need of a separate freestanding remote container. In some embodiments, the standing remote sleeve is comprised of injected molded plastics and silicone materials. In some embodiments, the sleeve slides onto the remote through an opening on the top end, bottom end, or the sides of the remote enabling the remote to pass through for installation of the standing sleeve.

In one embodiment, the remote sleeve slides onto the remote through an opening on the top end of the structure enabling the remote to pass through for installation. In one embodiment, the remote sleeve is comprised of an enclosure wherein the structure of the sleeve that is designed at a tilted angle of 5 degrees.

In one embodiment, the remote sleeve is comprised of an enclosure wherein the bottom of the sleeve has a widened base on the rear side that redistributes the weight of the remote serving as a counterbalance and structure support enabling in to stand.

In one embodiment, the remote sleeve is comprised of an enclosure wherein the bottom of the sleeve has a widened base on the rear side that redistributes the weight of the remote serving as a counterbalance and structure support enabling in to stand wherein the measurement of the base are 40 mm on the widest section and tapers down to 16 mm on the shortest width, the length measures 24 mm from the front of the sleeve to the back of the sleeve, the base extends 50 mm from the bottom surface to the middle back of the sleeve at a −10 degree angle to help counteract the downward weight of the remote keeping it standing in place. Accordingly, when the user inserts their remote fully into the sleeve, they are able to stand the remote on a flat surface as the bottom of the sleeve has a widened base on the rear side that provides standing support and rebalances the weight of the remote allowing it to stand.

In one embodiment, the front side of the standing remote sleeve comprises an opening to give the user access to the remote buttons and controls. In one embodiment, both sides of the sleeve, bottom side and rear side wrap around the contours of the remote providing full housing coverage while protecting the remote from scuffs when dropped and gives added gripability when the user picks the remote off a surface or when the user is accessing and using the controls of the remote.

In one embodiment, top side of the remote sleeve has an opening allowing functionality of the infrared sensor to communicate to the infrared receiver.

In one embodiment, the standing remote sleeve comprised a widened base to support the remote weight and serve as a support and counterbalance enabling the remote to stand.

In one embodiment, the wall thickness, e.g., 1.5 mm wall thickness, of the silicone sleeve layer allows for coverage of the remote as well as magnet functionality of the rear battery housing. This thickness enables the remote to be used in conjunction with a magnet remote mount.

In some embodiments, e.g., for remote sleeves compatible with the Amazon Fire TV remotes, the wall thickness of the standing sleeve measures 1.5 mm.

In some embodiments, e.g., for remote sleeves compatible with the Amazon Fire TV remotes, the standing remote sleeve comprises an integrated stand that is tilted at an angle of 5 degrees relative to the structure of the flat portion of the remote sleeve.

In some embodiments, the remote sleeve comprised of an enclosure wherein the bottom of the sleeve has a widened base on the rear side that redistributes the weight of the remote serving as a counterbalance and structure support enabling in to stand, and wherein the measurement of the base extending from the bottom surface to the middle back of the sleeve, and the angle to help counteract the downward weight of the remote keeping it standing in place have a ratio of 1% to 99%, 2% to 98%, 3% to 97%, 4% to 96%, 5% to 95%, 10% to 90%, 20% to 80%, 30% to 70%, 40% to 60%, 50% to 50%, 60% to 40%, 70% to 30%, 80% to 20%, 90% to 10%, 95% to 5%, 96% to 4%, 97% to 3%, 98% to 2%, or 99% to 1% or about 1% to about 99%, about 2% to about 98%, about 3% to about 97%, about 4% to about 96%, about 5% to about 95%, about 10% to about 90%, about 20% to about 80%, about 30% to about 70%, about 40% to about 60%, about 50% to about 50%, about 60% to about 40%, about 70% to about 30%, about 80% to about 20%, about 90% to about 10%, about 95% to about 5%, about 96% to about 4%, about 97% to about 3%, about 98% to about 2%, or about 99% to about 1%, or any ratio within a range defined by any two of the aforementioned percentages.

### BRIEF DESCRIPTION OF THE DRAWINGS

In addition to the features described above, additional features and variations will be readily apparent from the following descriptions of the drawings and exemplary embodiments. It is to be understood that these drawings depict typical embodiments and are not intended to be limiting in scope.

FIGS. 1A-1F depict an exemplary sleeve configured to accept a remote and maintain a predetermined angular orientation when placed on a flat surface, according to certain aspects of the present disclosure.

FIGS. 2A-2F depict a second exemplary embodiment of a sleeve configured to accept a control device and maintain an upright orientation on a flat surface, according to certain aspects of the present disclosure.

FIGS. 3A-5B depict a third exemplary embodiment of a sleeve configured to accept a control device and maintain an upright orientation on a flat surface, according to certain aspects of the present disclosure.

FIG. 6A depicts a typical remote control.

FIGS. 6B-6D depict a fourth exemplary embodiment of a sleeve configured to accept a control device and maintain an upright orientation on a flat surface, according to certain aspects of the present disclosure.

FIGS. 7A-7D depicts a fifth exemplary embodiment of a standing remote sleeve system 700 configured to accept a control device 10 and maintain an upright orientation on a flat surface, according to certain aspects of the present disclosure.

FIGS. 8A-8E depicts a sixth exemplary embodiment of a standing remote sleeve system 800 configured to accept an Apple Siri remote control device 10 and maintain an upright orientation on a flat surface, according to certain aspects of the present disclosure.

FIGS. 9A-9F depicts a seventh exemplary embodiment of a standing remote sleeve system 900 configured to accept a Roku Express remote control device 10 and maintain an upright orientation on a flat surface, according to certain aspects of the present disclosure.

FIGS. 10A-10E depicts an eighth exemplary embodiment of a standing remote sleeve system 1000 configured to accept an Alexa Voice remote control device 10 and maintain an upright orientation on a flat surface, according to certain aspects of the present disclosure.

FIGS. 11A-11F depicts a ninth exemplary embodiment of a standing remote sleeve system 1100 configured to accept an Alexa remote control device 10, e.g., an Alexa third generation remote control device, and maintain an upright orientation on a flat surface, according to certain aspects of the present disclosure.

FIGS. 12A-12B depicts a tenth exemplary embodiment of a standing remote sleeve system 1200 with embedded lights and configured to accept a control device 10 and maintain an upright orientation on a flat surface, according to certain aspects of the present disclosure.

FIGS. 13A-13D depicts an eleventh exemplary embodiment of a standing remote sleeve system 1300 configured to accept a Roku Voice remote control device 10 and maintain an upright orientation on a flat surface, according to certain aspects of the present disclosure.

### DETAILED DESCRIPTION

Provided herein are standing remote sleeves, e.g., media remote sleeves, that enable a remote to stand on a flat surface. The standing remote sleeves of the present invention are specifically engineered to facilitate the stable upright placement of television, smart streaming, or multi-media remotes on flat surfaces. The design of the standing remote sleeve of the present invention offers users a convenient storage option, ensuring the remote remains visible on a tabletop or any other flat surface post-use.

In certain embodiments, the standing remote sleeve of the present invention has additional integrated features that individually, or collectively, enhance the remote's functionality and/or enhance user's ability to locate the remote within the vicinity if misplaced. These embodiments include, but are not limited to, the incorporation of a silicone material in the standing remote sleeve of the present invention, the utilization of a diverse color selection in the standing remote sleeve of the present invention, the incorporation of a night-time glow effect in the standing remote sleeve of the present invention, the incorporation of embedded lights in the remote standing sleeve of the present invention, the integration of a tracker device holder or cavity in the standing remote sleeve of the present invention, the incorporation of uniquely positioned speaker cut-outs in the standing remote sleeve of the present invention, augmenting the size of the standing remote sleeve of the present invention to improve the ergonomics of the remote and further enhance the user's ability to locate the remote, incorporating a magnet in the standing remote sleeve of the present invention, and/or incorporation a wall thickness of the standing remote sleeve, e.g., 1.5 mm wall thickness of the silicone standing remote sleeve, such that the sleeve layer allows for coverage of the remote as well as utilization of the magnet functionality from the remote itself which enables the remote to be used in conjunction with a magnet remote mount.

Accordingly, the present invention addresses an unmet need for an accessory that can be integrated with the remote and enable the remote to stand in an elevated position above a flat surface thereby making it more visible to the user and reducing the likelihood of it being obstructed by other items on the surface.

Embodiments of the present invention can be used with any type of remote control device shown in, for example, Table 1, e.g., remotes that work with Amazon Fire® devices or other Streaming Device Remotes, including, but not limited to, Roku®—Roku® Voice Remote/Roku® Voice Remote Pro, Apple TV® Remote—Siri® Remote (2nd Gen or 3rd Gen), Google TV™ Streamer—Google Chromecast™ with Google TV™ Remote, NVIDIA® Shield Pro—NVIDIA® Shield™ Remote, TiVo®—TiVOR Stream 4K Remote/TiVOR VOX™ Remote, Amazon Fire TVR Cube—Alexa® Voice Remote (3rd Gen), ONN™—ONN™ Android TV™ Remote, SuperBox S5 PRO™ by TV Technologies LLC—SuperBox S5 PRO™ Remote.

Embodiments of the present invention can also be used with any type of remote control device shown in for example Table 2, e.g., remotes that work with TV Brand Remotes: Sony®—Sony® Bravia® Smart TV Remote, Samsung®—Samsung® Smart Remote/Samsung® One Remote™, LG®—LGR Magic Remote™, Hisense®—Hisense® Voice Remote/Hisense® Standard IR Remote, TCL®—TCL® Roku® TV Remote/TCL® Android TV™ Remote, Vizio®—Vizio® XRT—Series Remote/Vizio® SmartCast™ Remote, Philips®—Philips® Universal Remote/Philips® Smart TV Remote, Panasonic®—Panasonic® VIERA® Remote/Panasonic® Smart TV Remote, Sharp®—Sharp® AQUOS® Remote/Sharp® Roku® TV Remote.

TABLE 1
Examples of Streaming Device Remotes

Roku ®:

Roku ® Voice Remote
Roku ® Voice Remote Pro

Apple TV ®:

Siri ® Remote (2nd Generation)
Siri ® Remote (3rd Generation)

Google TV ™:

Chromecast with Google TV ™ Voice
Remote

NVIDIA ® Shield TV:

NVIDIA ® Shield TV Remote

TiVo ®:

```
TiVo ® VOX Remote
      TiVo ® Stream 4K Remote
      Amazon Fire TV ®:
  Alexa Voice Remote (3rd Generation)
        ONN ™:
    ONN ™ Android TV Remote
      SuperBox S5 PRO:
      SuperBox S5 PRO Remote
```

TABLE 2
Examples of Television Brand Remotes:

```
            Sony ®:
Sony ® Bravia ® TV Remote Control
        Samsung ®:
      Samsung ® One Remote
              LG ®:
        LG ® Magic Remote
          Hisense ®:
    Hisense ® TV Remote Control
            TCL ®:
      TCL ® Roku ® TV Remote
    TCL ® Android TV Remote
            Vizio ®:
    Vizio ® XRT-Series Remote
          Philips ®:
  Philips ® Universal Remote Control
        Panasonic ®:
  Panasonic ® TV Remote Control
            Sharp ®:
    Sharp ® Roku ® TV Remote
```

In embodiments, that integrate a tracker device holder or cavity in the standing remote sleeve of the present invention, the standing remote sleeve comprises strategically positioned hole cut-outs along the bottom and sides. In such embodiments, the standing remote sleeve comprises a cavity that can incorporate at least two or more different types of device trackers. In preferred embodiments, the standing remote sleeve comprises one cavity compatible with at least two device trackers. For example, in certain embodiments of the invention, the standing remote sleeve can integrate two or more tracking devices, selected from the group comprising, Apple® AirTag®, a Tile Pro®, a Tile Mate®, a Tile Slim®, a Tile Sticker®, and a Samsung Galaxy SmartTag®. device trackers, providing users the ability to use their existing tracker solutions for locating misplaced remotes. In preferred embodiments the standing remote sleeve of the present invention can integrate with either Apple® AirTag® or a Tile Mate® tracking device.

In such embodiments, the cavity orientation of the tracker device is strategically aligned to position the speakers of the trackers to direct the audible sound toward the back of the remote which facilitates the reflection of sound off the back of the remote housing instead of the standing remote sleeve, allowing it to escape the enclosed cavity through at least one of a bottom cut-out speaker channel and a side cut-out speaker channel in the standing remote sleeve of the present invention. The orientation of the cavity is critical because tracker devices oriented towards the silicone wall instead of through the bottom and side speaker cut-outs result in a muffling and distortion of the audible chime or sound from the tracker device, thereby compromising the effectiveness of locating the remote when lost.

In yet other embodiments, the standing remote sleeves of the present invention can be used with television smart streaming or multi-media remotes equipped with built-in tracking functionality. In these embodiments, the standing remote sleeve comprises strategically positioned hole cut-outs along the bottom and sides. The strategically positioned hole cut-outs along the bottom and sides of the standing remote sleeve enables the audible chime of these trackers to be clearly heard when activated, further enhancing the user's ability to locate the remote.

In certain embodiments, the standing remote sleeve of the present invention augments the overall size of the remote, contributing to a more comfortable grip during usage. In such embodiments, the standing remote sleeve's width and depth is increased to 100%, 200%, 300%, 400% or greater relative to the size of the enclosed remote, ensuring an ergonomic and user-friendly design that enhances the overall handling experience.

In certain embodiments, the standing remote sleeve of the present invention has embedded lights. By way of example and not limitation, integrated LED shines on buttons when triggered by pressure points by means of wires which relay pressure sensor trigger to main board to activate and light up the LED.

In one embodiment, the remote sleeve has an integrated stand feature built into the housing of the structure allowing the user to stand their remote without the need of a separate freestanding remote container. In some embodiments, the standing remote sleeve is comprised of injected molded plastics and silicone materials. In some embodiments, the sleeve slides onto the remote through an opening on the top end, bottom end, or the sides of the remote enabling the remote to pass through for installation of the standing sleeve.

In one embodiment, the remote sleeve slides onto the remote through an opening on the top end of the structure enabling the remote to pass through for installation. In one embodiment, the remote sleeve is comprised of an enclosure wherein the structure of the sleeve that is designed at a tilted angle of 5 degrees.

In one embodiment, the remote sleeve is comprised of an enclosure wherein the bottom of the sleeve has a widened base on the rear side that redistributes the weight of the remote serving as a counterbalance and structure support enabling in to stand.

In one embodiment, the remote sleeve is comprised of an enclosure wherein the bottom of the sleeve has a widened base on the rear side that redistributes the weight of the remote serving as a counterbalance and structure support enabling in to stand wherein the measurement of the base are 40 mm on the widest section and tapers down to 16 mm on the shortest width, the length measures 24 mm from the front of the sleeve to the back of the sleeve, the base extends 50 mm from the bottom surface to the middle back of the sleeve at a −10 degree angle to help counteract the downward weight of the remote keeping it standing in place. Accordingly, when the user inserts their remote fully into the sleeve, they are able to stand the remote on a flat surface as the bottom of the sleeve has a widened base on the rear side that provides standing support and rebalances the weight of the remote allowing it to stand.

In one embodiment, the front side of the standing remote sleeve comprises an opening to give the user access to the remote buttons and controls. In one embodiment, both sides of the sleeve, bottom side and rear side wrap around the contours of the remote providing full housing coverage while protecting the remote from scuffs when dropped and gives added gripability when the user picks the remote off a surface or when the user is accessing and using the controls of the remote.

In one embodiment, top side of the remote sleeve has an opening allowing functionality of the infrared sensor to communicate to the infrared receiver.

In one embodiment, the standing remote sleeve comprised a widened base to support the remote weight and serve as a support and counterbalance enabling the remote to stand.

In one embodiment, the wall thickness, e.g., 1.5 mm wall thickness, of the silicone sleeve layer allows for coverage of the remote as well as magnet functionality of the rear battery housing. This thickness enables the remote to be used in conjunction with a magnet remote mount.

In some embodiments, e.g., for remote sleeves compatible with the Amazon Fire TV remotes, the wall thickness of the standing sleeve measures 1.5 mm.

In some embodiments, e.g., for remote sleeves compatible with the Amazon Fire TV remotes, the standing remote sleeve comprises an integrated stand that is tilted at an angle of 5 degrees relative to the structure of the flat portion of the remote sleeve.

In some embodiments, the remote sleeve comprised of an enclosure wherein the bottom of the sleeve has a widened base on the rear side that redistributes the weight of the remote serving as a counterbalance and structure support enabling in to stand, and wherein the measurement of the base extending from the bottom surface to the middle back of the sleeve, and the angle to help counteract the downward weight of the remote keeping it standing in place have a ratio of 1% to 99%, 2% to 98%, 3% to 97%, 4% to 96%, 5% to 95%, 10% to 90%, 20% to 80%, 30% to 70%, 40% to 60%, 50% to 50%, 60% to 40%, 70% to 30%, 80% to 20%, 90% to 10%, 95% to 5%, 96% to 4%, 97% to 3%, 98% to 2%, or 99% to 1% or about 1% to about 99%, about 2% to about 98%, about 3% to about 97%, about 4% to about 96%, about 5% to about 95%, about 10% to about 90%, about 20% to about 80%, about 30% to about 70%, about 40% to about 60%, about 50% to about 50%, about 60% to about 40%, about 70% to about 30%, about 80% to about 20%, about 90% to about 10%, about 95% to about 5%, about 96% to about 4%, about 97% to about 3%, about 98% to about 2%, or about 99% to about 1%, or any ratio within a range defined by any two of the aforementioned percentages.

### Definitions

Unless otherwise defined, all words used herein have the same meaning as commonly understood by one of ordinary skill in the art to which this subject matter belongs. The terminology used in the description of the subject matter herein is for the purpose of describing particular embodiments only and is not intended to be limiting of the subject matter.

As used herein, the terms and phrases “remote control device,” “remote control,” “control device,” and “remote” and similar interchangeably refer to an electronic device used to operate another device from a distance, including devices using radio frequency (RF) and infrared (IR) optical means of wireless signal transmission. A remote may operate entertainment devices such as a streaming device, a TV set, a smartphone, audio systems, gaming systems, or a DVD player, as other electronic devices, e.g., smart home devices, lighting, and heating and/or cooling systems. Remotes may be associated with a single device, control multiple devices, or be programmable “universal” remote controls.

As used herein, the terms “sleeve” and “cover” and “standing remote sleeve” and similar terms interchangeably refer to an enclosure with a compartment that is configured to accept a remote.

As used herein, the term “tracker” and phrase “tracking device” and similar interchangeably refer to a module that communicates its position to a remote system. The module may determine its position internally or by interaction with another system, e.g., a proximate smart phone. Examples of tracking devices include an Apple® AirTag®, a Tile Pro®, a Tile Mate®, a Tile Slim®, a Tile Sticker®, and a Samsung Galaxy SmartTag®.

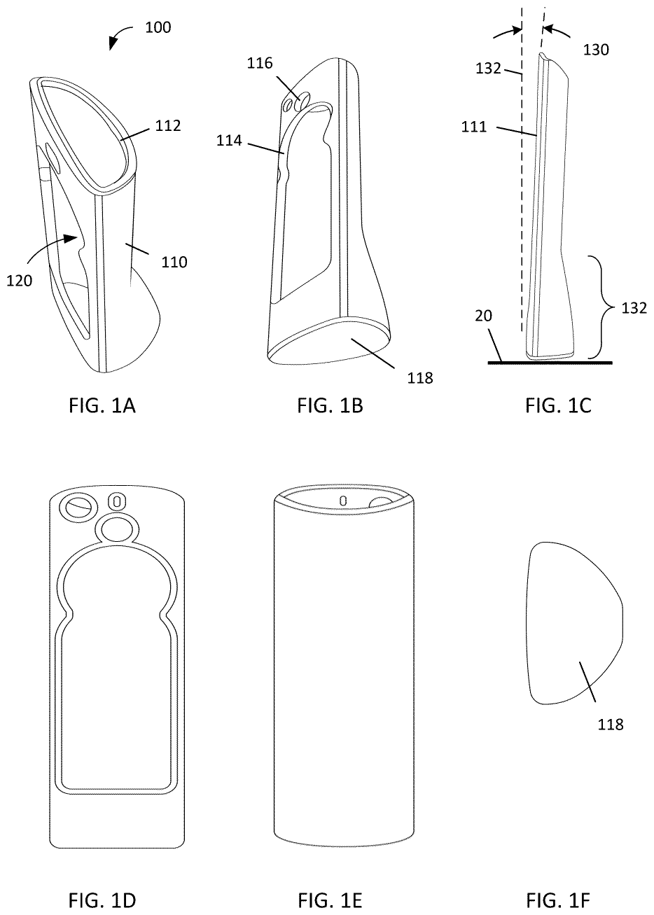

FIGS. 1A-1C depict an exemplary standing remote sleeve 100 configured to accept a remote and maintain a predetermined angular orientation when placed on a surface 20, e.g., a table top, according to certain aspects of the present disclosure. The standing remote sleeve 100 comprises a body 110 with an internal compartment 120 configured to receive a remote control (not shown) and a front opening 114 configured to provide access to control features of a remote disposed within the standing remote sleeve 100. In certain embodiments, the body 110 comprises a second opening 116 to enable operation of a feature of the remote, e.g., a microphone. In certain embodiments, the body 110 comprises a top opening 112 to enable transmission of a signal from the remote.

The body 110 comprises a base 118 configured such that the standing remote sleeve 100 stands generally upright when placed on a surface 20, as shown in FIG. 1C. In certain embodiments, the standing remote sleeve has a stable position wherein the front surface 111 of body 110 is positioned at an angle 130 from a vertical reference 132. In certain embodiments, the angle is in the range of 0-10 degrees. In certain embodiments, the angle is in the range of 10-80 degrees, 10-15 degrees, 15-25 degrees, 25-45 degrees, 45-80 degrees, or any combination or portion thereof. In certain embodiments, the body 110 comprises a portion 132 that is increased in size so as to increase the stability of the standing remote sleeve 100 in the upright position.

FIGS. 1D-1F respectively depict a front view, a back view, and a bottom view of an exemplary embodiment of standing remote sleeve 100. FIG. 1D depicts the physical structure is made of injected molded silicone material that is contoured to fit around the remote. The front side of the remote has an opening to give the user access to the remote buttons and controls. Both sides of the sleeve, bottom side and rear side wrap around the contours of the remote providing full housing coverage while protecting the remote from scuffs when dropped and gives added grip-ability when the user picks the remote off a surface or when the user is accessing and using the controls of the remote. The top side has an opening allowing functionality of the infrared sensor to communicate to the infrared receiver. FIG. 1E The rear bottom side has a widened base to support the remote weight and serve as a support and counterbalance enabling the remote to stand. The wall thickness (1.5 mm) of the silicone sleeve layer allows for coverage of the remote as well as magnet functionality of the rear battery housing. This thickness enables the remote to be used in conjunction with a magnet remote mount.

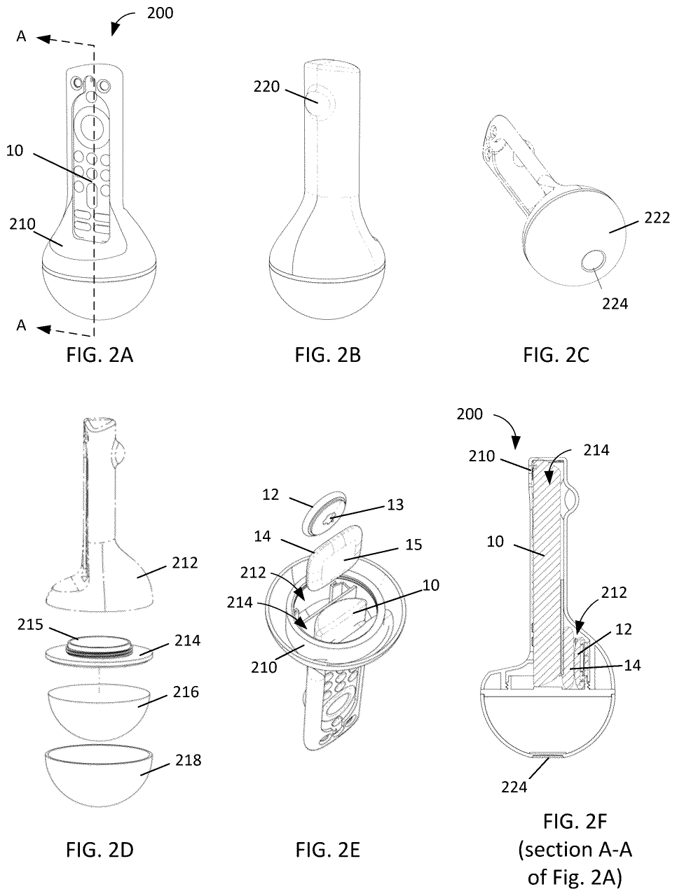

FIGS. 2A-2C depict a second exemplary embodiment of a standing remote sleeve 210 configured to accept a remote control device 10 and maintain an upright orientation of the integrated assembly 200 when placed on a flat surface, according to certain aspects of the present disclosure. In certain embodiments, the standing remote sleeve 210 comprises a bumper 220 that provides a gripping feature that the user may use to grip the remote, e.g., positioning the bumper 220 between middle and index fingers, and counterbalance the overall weight of the remote when held. In certain embodiments, the bumper 220 acts as a stop that limits rolling of the assembly 200 when placed on its back on a flat surface. The standing remote sleeve 210 comprises a convex base 222 that allows the assembly 200 to be placed in contact with the table at an angle and self-rotate to a stable upright position. In certain embodiments, the convex base 222 comprises a stabilization feature 224, e.g., a flat spot at the point of stable contact with a flat surface, i.e. abottom base lip design that assists the remote sleeve in standing upright when rocking back and forth. In FIG. 2A, the remote is centered directly above counterweight to focus total weight at the center point of the design

FIG. 2D is an exploded view of the standing remote sleeve 210. The standing remote sleeve comprises a upper housing 212 and a lower housing 218. In an exemplary embodiment, the housings 212, collectively enclose a closure disk 214 comprising a feature, e.g., a glue joint, to connect to the lower housing 218 and a portion 215 configured, e.g., mechanical threads around a periphery of the portion 214, to couple to the upper housing 212.

In certain embodiments, a weight 216 is disposed within the lower housing 218 so as to position the center of gravity (CG) of the integrated assembly 200. In certain embodiments, the CG is positioned so as to urge the standing remote sleeve 210 to rotate toward a predetermined position or angle, e.g., the stable position of FIG. 1C.

FIG. 2E is a partial exploded view of the integrated assembly 200 and FIG. 2F is a cutaway side view of the integrated assembly 200 according to section line A-A of FIG. 1A. Together FIGS. 2E-2F depict an exemplary embodiment of how the remote 10 and trackers 12, 14 are integrated into the standing remote sleeve 210. The standing remote sleeve 210 comprises a compartment 214 containing a remote 10 and a compartment 212 containing two trackers 12, 14. In certain embodiments, the compartment 212 is configured to accept either or both of an Apple AirTag 12 and a Tile Mate 14. AirTag and Tile Mate cavities orientations direct both tracker's speakers towards the back of the remote

In certain embodiments, the compartment 212 comprises locating features that accept the trackers 12, 14 in a predetermined orientation. In certain embodiments, the standing remote sleeve 210 comprises one or more custom guides (not visible in FIG. 2E) that are keyed to features of a specific tracker. In certain embodiments, the custom guides are provided separate from the housing 212 and are selected for use based on the specific tracker to be used. In certain embodiments, the compartment features accept the trackers 12, 14 in an orientation such that the sound-emitting surfaces of the trackers 12, 14, e.g., surface 13 of the AirTag 12 and surface 15 of the Mate 14, are facing the remote 10 such that sound emitted from the surfaces 13, 15 is redirected by the remote 10 to the external environment, e.g., to increase the volume of the sound in the vicinity of the integrated assembly 200.

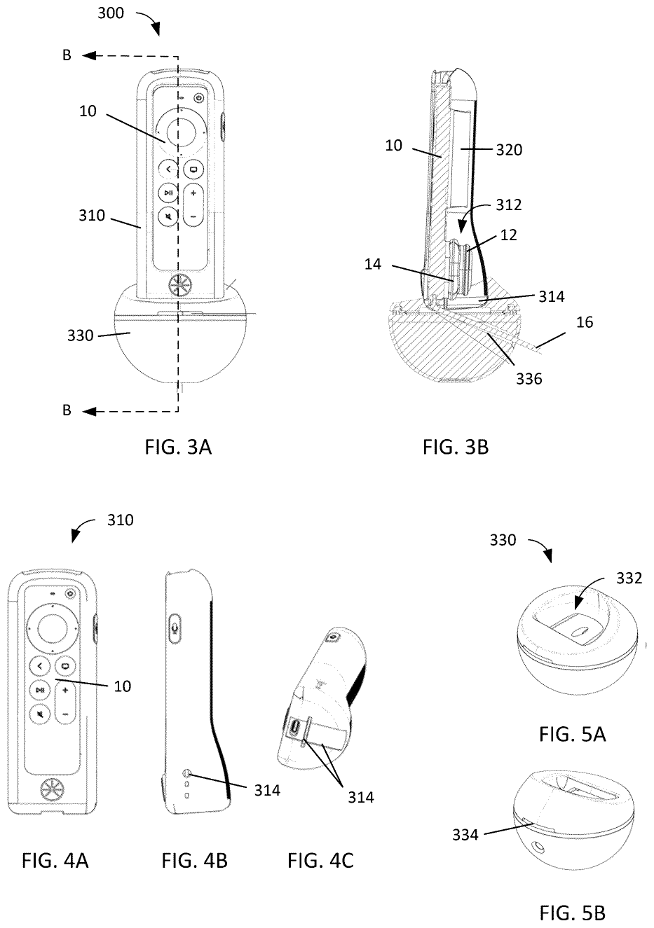

FIG. 3A depicts a third exemplary embodiment of a standing remote sleeve system 300 configured to accept a control device 10 and maintain an upright orientation on a flat surface, according to certain aspects of the present disclosure. The system 300 includes a separable standing remote sleeve 310 and a docking base unit 330, wherein the base unit 330 remains on the flat surface when the standing remote sleeve 310 is picked up by a user.

FIG. 3B is a section view according to section line B-B of FIG. 3A. A magnet 320 is disposed within the standing remote sleeve 310 such that the standing remote sleeve 310 may be attached to a metal surface (not shown) while the standing remote sleeve 310 is separate from the base unit 330. Trackers 12, 14 are shown disposed behind the remote 10 within compartment 312 of the standing remote sleeve 310. In certain embodiments, the trackers 12,14 are oriented with their respective sound-emitting surfaces directed away from the remote 10, i.e., toward the open space of compartment 312, in order to allow the sound to resonate and be louder external to the standing remote sleeve 310. In certain embodiments, a channel 314 is formed in the standing remote sleeve 310 so as to further convey the emitted sound to the external environment. In certain embodiments, the base unit 330 comprises a passage 336 configured to accept a changing cable 16 that is associated with the remote 10. In certain embodiments, the base unit 330 comprises a feature (not visible in FIG. 3B) that positions a plug of the charging cable 16 to mate with the remote 10 when the remote 10 is placed in the base unit 330.

FIGS. 4A-4B respectively depict exemplary front and side views of the separable standing remote sleeve 310 of FIG. 3A. In certain embodiments, another sound channel 314 is formed in the side of the standing remote sleeve 310, connecting the internal compartment 312 to the external environment.

FIG. 4C depicts a view from under the separable unit 310 that depicts further exemplary sound transmission channels 314 that direct sound from trackers 12, 14 to the outside of the standing remote sleeve 310.

FIGS. 5A-5B respectively depict front and rear perspective views of the base unit 330. The base unit comprises a pocket 332 configured to receive the separable standing remote sleeve 310. In certain embodiments, the base unit 330 comprises a sound transmission channel 334 that directs sound from standing remote sleeve 310, e.g., from the sound transmission channels 314, to the external environment.

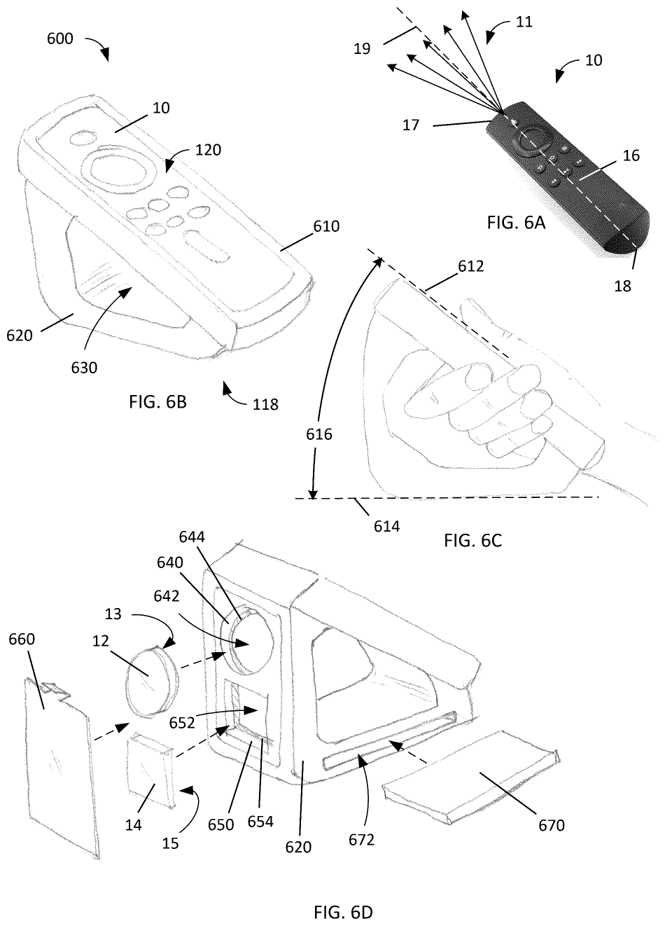

FIG. 6A depicts a representative remote control 10. The remote 10 comprises a top surface 16, a front surface 17, and a back surface 18. The remote 10 has an axis 19 that is oriented in a front-back direction. The top surface is generally parallel to axis 19 in the front-back direction and may be curved in the direction perpendicular to axis 19. The remote 10 emits an optical signal beam 11 from a portion of the front surface 17 although certain types of remote 10 transmit radio frequency (RF) signals either in addition to or instead of the optical beam 11. The remote 10 is one of a single-unit remote, e.g., configured to operate only a single device or a brand such as Amazon®, and a “universal” remote, e.g., can be configured to operate multiple devices or brands of devices.

FIGS. 6B-6D depict a fourth exemplary embodiment of a standing remote sleeve 600 configured to accept a control device 10 and maintain an upright orientation on a flat surface, according to certain aspects of the present disclosure. The angled standing remote sleeve 600 comprises a body 610, a support 620 coupled to the body 610 to form a grip opening 630.

FIG. 6C is a side view of the standing remote sleeve 600 that depicts a stable resting angle 616 with respect to a top surface 612 of the body 610 and a flat surface 614, e.g., a table top. In certain embodiments, the top surface 612 is parallel to axis 19 of the remote 10. The support 620 comprises a base (not visible in FIG. 6C) that is in contact with the surface 614. The standing remote sleeve is considered to be in “stationary contact” when the base is in contact with the surface 614 and standing remote sleeve 600 is not moving or rotating with respect to the surface 614. In certain embodiments, the resting angle is in one of the ranges of 0-80 degrees, 0-20 degrees, 20-60 degrees, 40-50 degrees, or any combination or portion thereof.

FIG. 6D depicts a partially exploded view of the standing remote sleeve 600. In certain embodiments, the support 620 comprises a compartment 640 configured to accept a first tracker, e.g., an AirTag and a separate compartment 650 configured to accept a different tracker, e.g., a Tile Mate. In certain embodiments, the compartments 640, 650 are configured to accept only a particular tracker, e.g., compartment 640 will not accept the Tile Mate while compartment 650 will not accept the AirTag. In certain embodiments, the compartments 640, 650 comprise acoustic openings 642, 652 that expose a portion of the sound-emitting surface 13, 15 of trackers 12, 14, thereby increasing the volume of emitted sound in the vicinity of the standing remote sleeve 600. In certain embodiments, the compartments 640, 650 comprise retention features 644, 654, e.g., ridges around the openings 642, 652. In certain embodiments, an access cover 660 is removably coupled over the compartments 640, 650 to retain accepted trackers 12,14 in the compartments 640, 650.

In certain embodiments, the support 620 comprises a weight 670 that fits into compartment 672 that is disposed between the compartment 120 and the base 118 so as to move the CG of the sleeve 600 closer to the base 118 of the support and increase the stability of the standing remote sleeve 600 when positioned on a table top.

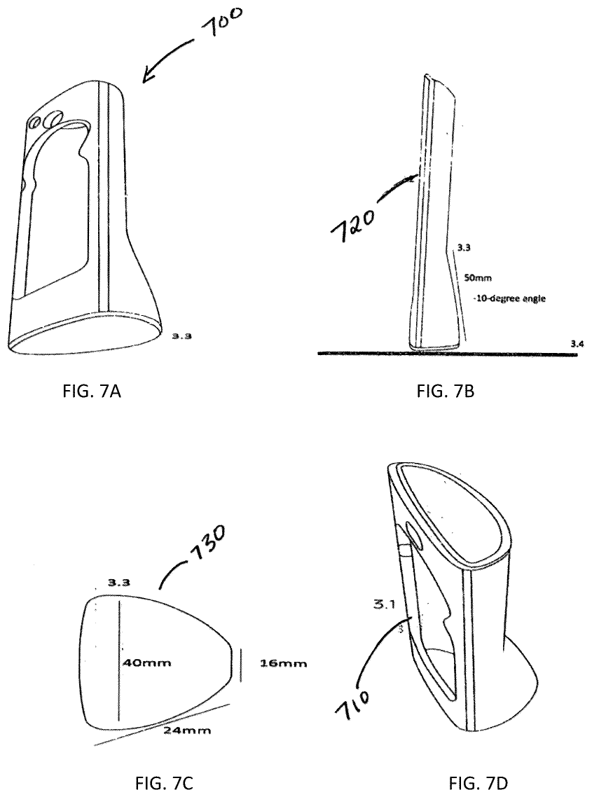

FIG. 7A-7D depicts a fifth exemplary embodiment of a standing remote sleeve system 700 configured to accept a control device 10 and maintain an upright orientation on a flat surface, according to certain aspects of the present disclosure. The remote is installed into the sleeve through an opening in the front facing facade of the structure. The wall thickness 710 measures 1.5 mm. The enclosure and structure of the sleeve 720 is designed at a tilted angle of 87 degrees. The bottom of the sleeve has a widened base 730 on the rear side that redistributes the weight of the remote serving as a counterbalance and structure support enabling in to stand. Measurements of the base are 40 mm on the widest section and tapers down to 16 mm on the shortest width. The length measures 24 mm from the front of the sleeve to the back of the sleeve. The base extends 50 mm from the bottom surface to the middle back of the sleeve at a 10-degree angle to help counteract the downward weight of the remote keeping it standing in place. When the user inserts their remote fully into the sleeve, they are able to stand the remote on a flat surface as the bottom of the sleeve has a widened base on the rear side that provides standing support and rebalances the weight of the remote allowing it to stand.

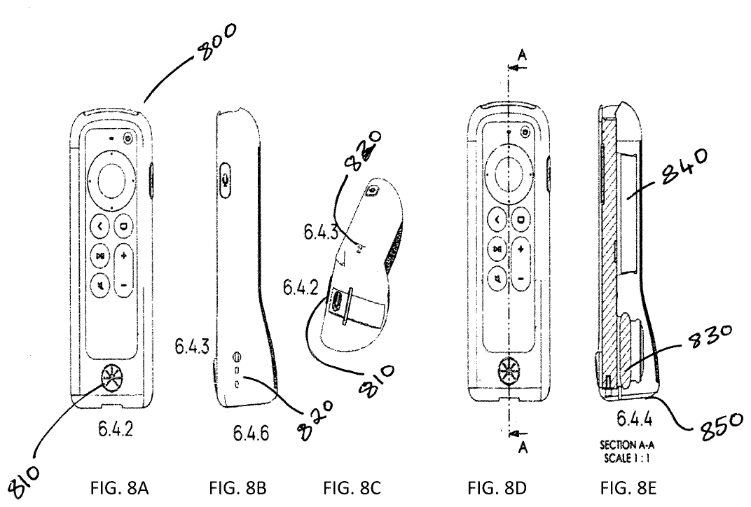

FIG. 8A-8E depicts a sixth exemplary embodiment of a standing remote sleeve system 800 configured to accept an Apple Siri remote control device 10 and maintain an upright orientation on a flat surface, according to certain aspects of the present disclosure. Bottom cut-out speaker channel 810 enables sound to travel from AirTag, Tile Mate tracker device or remotes with a built-in locator feature. Side cut-out speaker channel 820 enables sound to travel from AirTag, Tile Mate tracker device or remotes with built-in locator feature. Internal cavity 830 holds both AirTag and Tile Mate device trackers. AirTag and Tile Mate cavities 830 are oriented for the internal speakers to face the back of the remote. This allows the sound to reflect off the back of the remote and exit out both speaker cutout holes. The remote sleeve rear backwall cavity houses a magnet 840 which allows the user to affix the remote onto any metal source for easy storage and accessibility. Bottom of the sleeve has a widened base 850 on the rear side that redistributes the weight of the remote serving as a counterbalance and structure support enabling the remote stand vertically on a flat surface. FIG. 8E depicts the interior cavity view-AirTag and Tile Mate orientation directs speakers facing the back wall of the remote. An audible chime from the tracker is directed toward the back of the remote which facilitates the reflection of sound off the back of the remote housing instead of the standing remote sleeve, allowing it to escape the enclosed cavity through at least one of a bottom cut-out speaker channel and a side cut-out speaker channel. The side cut-out speaker channel is located on the side wall. The bottom cut-out speaker channel is located at the bottom of the sleeve.

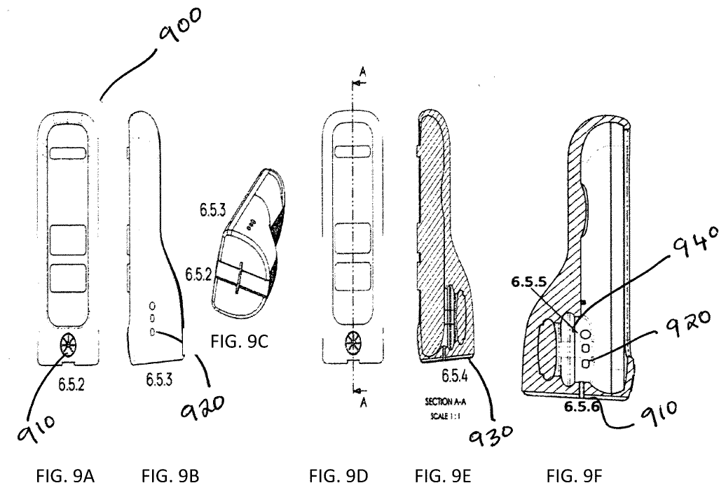

FIG. 9A-9F depicts a seventh exemplary embodiment of a standing remote sleeve system 900 configured to accept a Roku Express remote-control device 10 and maintain an upright orientation on a flat surface, according to certain aspects of the present disclosure. Bottom cut-out speaker channel 910 enables sound to travel from AirTag, Tile Mate tracker device or remotes with built-in locator feature. Side cut-out speaker channel 920 enables sound to travel from AirTag, Tile Mate tracker device or remotes with built-in locator feature. Bottom of the sleeve has a widened base 930 on the rear side that redistributes the weight of the remote serving as a counterbalance and structure support enabling the remote stand vertically on a flat surface. FIG. 9F depicts the interior cavity view-AirTag and Tile Mate orientation 940 directs speakers facing the back wall of the remote. Audible chime is able to exist through two speaker hole cut-outs. The first cutout 920 is located on the side wall. The second speaker cut-out 910 is located at the bottom of the sleeve.

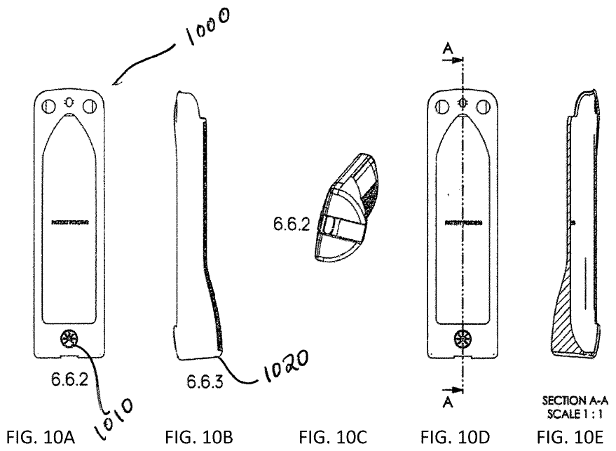

FIG. 10A-10E depict an eighth exemplary embodiment of a standing remote sleeve system 1000 configured to accept an Alexa Voice remote control device 10 and maintain an upright orientation on a flat surface, according to certain aspects of the present disclosure. Bottom cut-out speaker channel 1010 enables sound to travel from AirTag, Tile Mate tracker device or remotes with built-in locator feature. Bottom of the sleeve has a widened base 1020 on the rear side that redistributes the weight of the remote serving as a counterbalance and structure support enabling the remote stand vertically on a flat surface

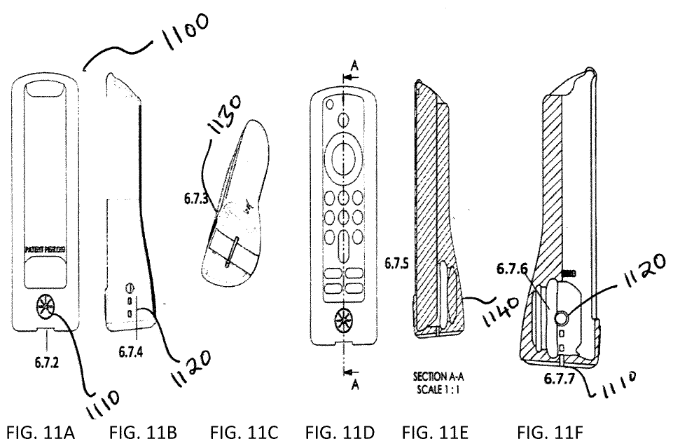

FIGS. 11A-11F depict a ninth exemplary embodiment of a standing remote sleeve system 1100 configured to accept an Alexa remote control device 10, e.g., an Alexa third generation remote control device, and maintain an upright orientation on a flat surface, according to certain aspects of the present disclosure. Bottom cut-out speaker channel 1110 enables sound to travel from AirTag, Tile Mate tracker device or remotes with built-in locator feature. Side cut-out speaker channel 1120 enables sound to travel from AirTag, Tile Mate tracker device or remotes with built-in locator feature. Bottom of the sleeve has a widened base 1130 on the rear side that redistributes the weight of the remote serving as a counterbalance and structure support enabling the remote stand vertically on a flat surface. Internal cavity 1140 holds both AirTag and Tile Mate device trackers. AirTag and Tile Mate cavities are oriented for the internal speakers to face the back of the remote. This allows the sound to reflect off the back of the remote and exit out both speaker cutout holes. FIG. 11F depicts interior cavity view-AirTag and Tile Mate orientation directs speakers facing the back wall of the remote. Audible chime is able to exist through two speaker hole cut-outs. The first cutout 1120 is located on the side wall. The second speaker cut-out 1110 is located at the bottom of the sleeve.

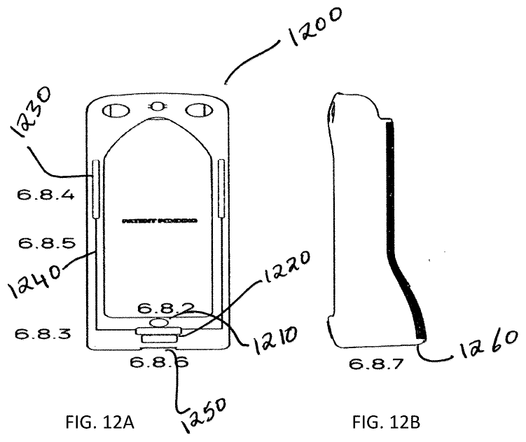

FIGS. 12A-B depict a tenth exemplary embodiment of a standing remote sleeve system 1200 with embedded lights and configured to accept a control device 10 and maintain an upright orientation on a flat surface, according to certain aspects of the present disclosure. Integrated LED 1210 shines on buttons when triggered by pressure points. Battery cell, PCB and LED electronics 1220. Pressure sensors 1230. Wires 1240 relay pressure sensor trigger to main board to activate and light up the LED. Bottom cut-out speaker channel 1250 enables sound to travel Alexa Voice Remote Pro when the Find My Remote feature is triggered. Bottom of the sleeve 1260 has a widened base on the rear side that redistributes the weight of the remote serving as a counterbalance and structure support enabling the remote stand vertically on a flat surface

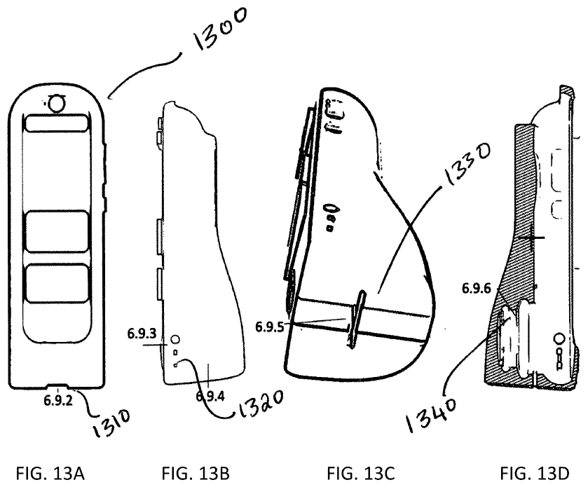

FIGS. 13A-13D depict an eleventh exemplary embodiment of a standing remote sleeve system 1300 configured to accept a Roku Voice remote control device 10 and maintain an upright orientation on a flat surface, according to certain aspects of the present disclosure. Bottom cut-out speaker channel 1310 enables sound to travel from AirTag, Tile Mate tracker device. Side cut-out speaker channel 1320 enables sound to travel from AirTag, Tile Mate tracker device. Bottom of the sleeve has a widened base 1330 on the rear side that redistributes the weight of the remote serving as a counterbalance and structure support enabling the remote stand vertically on a flat surface. Bottom cut-out speaker channel enables sound to travel from AirTag, Tile Mate tracker device. FIG. 13D depicts internal cavity 1340 that holds both AirTag and Tile Mate device trackers. AirTag and Tile Mate cavities are oriented for the internal speakers to face the back of the remote. This allows the sound to reflect off the back of the remote and exit out both speaker cutout holes.

In at least some of the previously described embodiments, one or more elements used in an embodiment can interchangeably be used in another embodiment unless such a replacement is not technically feasible. It will be appreciated by those skilled in the art that various other omissions, additions and modifications may be made to the methods and structures described above without departing from the scope of the claimed subject matter. All such modifications and changes are intended to fall within the scope of the subject matter, as defined by the appended claims.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

The articles “a” and “an” are used herein to refer to one or to more than one (for example, at least one) of the grammatical object of the article. By way of example, “an element” means one element or more than one element.

The terms “about” or “around” as used herein refer to a quantity, level, value, number, frequency, percentage, dimension, size, amount, weight or length that varies by as much as 30, 25, 20, 15, 10, 9, 8, 7, 6, 5, 4, 3, 2 or 1% to a reference quantity, level, value, number, frequency, percentage, dimension, size, amount, weight or length.

Ranges of values may be interpreted as either inclusive or exclusive of the bounding values. For example, a range of 10-100 may be interpreted at the lower limit as either “10 and greater” or “greater than 10” without departing from the scope of the invention.

Throughout this specification, unless the context requires otherwise, the words “comprise,” “comprises,” and “comprising” will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

The invention is generally disclosed herein using affirmative language to describe the numerous embodiments. The invention also includes embodiments in which subject matter is excluded, in full or in part, such as substances or materials, method steps and conditions, protocols, or procedures.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc.

As will also be understood by one skilled in the art all language such as “up to,” “at least,” “greater than,” “less than,” and the like include the number recited and refer to ranges which can be subsequently broken down into sub-ranges as discussed above. Finally, as will be understood by one skilled in the art, a range includes each individual member. Thus, for example, a group having 1-3 articles refers to groups having 1, 2, or 3 articles. Similarly, a group having 1-5 articles refers to groups having 1, 2, 3, 4, or 5 articles, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

All references cited herein, including but not limited to published and unpublished applications, patents, and literature references, are incorporated herein by reference in their entirety and are hereby made a part of this specification. To the extent publications and patents or patent applications incorporated by reference contradict the disclosure contained in the specification, the specification is intended to supersede and/or take precedence over any such contradictory material.

What is claimed is:

1. A standing remote sleeve, comprising:
a body;
a first compartment disposed within the body and configured to accept a remote; and
a base coupled to the body such that the remote is positioned at a predetermined angle with respect to a flat surface when the base is in stationary contact with the surface.

2. The standing remote sleeve of claim 1, wherein:
the body comprises a top surface; and
the predetermined angle is measured between the top surface and the flat surface.

3. The standing remote sleeve of claim 2, wherein the top surface of the body is generally parallel to a portion of a top surface of a remote that has been accepted into the first compartment.

4. The standing remote sleeve of claim 1, wherein the predetermined angle is within a range selected from the group containing 0-80 degrees, 0-20 degrees, 20-60 degrees, and 40-50 degrees.

5. The standing remote sleeve of claim 1, further comprising a cavity disposed within the body and configured to accept at least one tracking device.

6. The standing remote sleeve of claim 5, wherein the cavity is configured to orient an accepted tracking device such that a sound emitted by the tracking device is generally directed towards a back of the body thereby increasing a volume of the emitted sound in a vicinity of the standing remote sleeve.

7. The standing remote sleeve of claim 6, wherein the standing remote sleeve further comprises at least one of a bottom cut-out speaker channel and a side cut-out speaker channel thereby increasing a volume of the emitted sound in a vicinity of the standing remote sleeve.

8. The standing remote sleeve of claim 5, wherein the cavity is configured to accept a first tracking device or a second tracking device that is different from the first tracking device.

9. The standing remote sleeve of claim 1, further comprising:
a weight; and
a second compartment disposed within the body between the first compartment and the base and configured to accept the weight.

10. The standing remote sleeve of claim 9, wherein:
the base comprises a convex curvature that allows the standing remote sleeve to rotate over a defined range about the predetermined angle;
the standing remote sleeve comprises a center of gravity (CG); and
the second compartment is disposed such that, when the weight is disposed in the second compartment, the CG is positioned so as to urge the standing remote sleeve to rotate toward the predetermined angle.

11. The standing remote sleeve of claim 10, wherein the base comprises a stabilization feature configured to stabilize the standing remote sleeve at the predetermined angle.

12. A standing remote sleeve comprising a body having a stand feature.

13. The remote sleeve of claim 12, wherein the stand feature enables the body to stand upright on a flat surface.

14. The remote sleeve of claim 12, wherein the body comprises at least one of an injection molded plastic and a silicone material.

15. The remote sleeve of claim 12, wherein the body comprises one or more openings into an internal compartment.

16. The remote sleeve of claim 12, wherein the body also has a widened base.

17. The remote sleeve of claim 16, wherein the widened base is configured such that the body stands a positive angle of at least 5 degrees.

18. The remote sleeve of claim 16, wherein the widened base redistributes the weight of the remote thereby enabling the remote sleeve to stand.

19. The remote sleeve of claim 16, wherein the widened base is configured such that the body stands at a negative angle of at least negative 10 degrees.

20. The remote sleeve of claim 19, wherein the widened base measures:
a largest width of at least 40 mm;
a narrowest width of 16 mm or less;
a thickness from a front of the sleeve to a back of the sleeve of at least 24 mm; and
a height from a bottom surface to a middle of the body of at least 50 mm.
